(19) United States
(12) Patent Application Publication
(10) Pub. No.: US 2008/0086942 A1
(43) Pub. Date: Apr. 17, 2008

(54) Low profile office partition planter

(76) Inventor: Martin Donald Maier, Allegany, NY (US)

Correspondence Address: Martin D. Maier, 120 Nolan Drive, Allegany, NY, 14706, US

(21) Appl. No.: 11/974,446

(22) Filed: Oct. 13, 2007

Related U.S. Application Data
(60) Provisional application No. 60/851,397, filed on Oct. 14, 2006.

(51) Int. Cl. A01G 9/02

(52) U.S. Cl. 47/65.5

(57) ABSTRACT

A plant containing vessel that is modular in construction and attaches to narrow horizontal surfaces such as office partitions, movable walls, narrow ledges and window sills. It is a low profile design with a relatively small cross section that conforms to the approximate width and length of the surface to which it is mounted. The planter can accommodate a variety of organic or inorganic mediums. Active growing systems utilizing an air pump or water pump may be used as dictated by the oxygen requirements of the plants. The planter can exist as a stand-alone unit or be connected together to comprise a continuous network that extends across adjacent walls. Various means are described for securing the planter to the mounting surface. Various means are described for providing structural support to the plants. The support structures serves to raise the line of sight to promote privacy for the office occupants.

### REFERENCES CITED

### U.S. Patent Documents

Provisional Patent, Appl No. 60/851,397—Filing Date Oct. 14, 2006, Martin D. Maier

| | | | |
|---|---|---|---|
| 4,194,313 | March 1980 | Downing | 40/620 |
| 4,211,034 | July 1980 | Piesner | 47/59-64 |
| 4,415,091 | November 1983 | Wolff | 211/86 |
| D.257,993 | January 1981 | DeMars | D20/10 |
| 4,315,381 | February 1982 | Dvorin | 47/59 |
| 4,559,738 | December 1985 | Helfman | 47/66 |
| 4,698,936 | October 1987 | Helfman | 47/68 |
| 4,640,045 | February 1987 | Nesbitt et al. | 47/66 |
| 4912876 | May 1990 | Ginsberg | 47/33 |
| 4,926,585 | May 1990 | Dreschel | 47/59 |
| 312,983 | December 1990 | Powell | D11/156 |
| 5,177,899 | January 1993 | Powell | 47/66 |
| 5,368,267 | November 1994 | Howard | 248/231.4 |
| 5,822,918 | November 1994 | Allen | 248/231.4 |
| 5,822,918 | October 1998 | Helfman | 47/39 |
| 5,887,384 | March 1999 | Zaremba | 47/39 |
| 5,887,383 | March 1999 | Soeda | 47/59 |
| 6,012,690 | January 2000 | Cohen | 248/226.11 |
| 6,108,971 | August 2000 | Zaremba | 47/39 |

The present invention relates plant containing vessels, and more particularly to a plant containing vessels mountable to wall end surfaces.

### BACKGROUND OF THE INVENTION

Plant containing vessels or “planters” are generally known. Planters that are visually appealing and non-obstructive are desirable in an office environment, particularly when they can be mounted to previously unutilized surfaces such as office partitions, moveable walls, narrow ledges and window sills, as office space is often limited. A low profile planter design with a small cross sectional area satisfies this need. A consequence, however, of a small cross sectional area is that there is less growth medium and oxygen to support plant growth. In general, roots require oxygen whereas the stem and leaves require carbon dioxide. As some root systems requires more oxygen than what a simple passive system can provide, an active system may be used which facilitates the transfer of oxygen and nutrients to the roots which offsets this deficiency and promotes vigorous plant growth in the reduced area afforded by the subject invention.

### SUMMARY OF THE INVENTION

In one aspect, the present invention is a planter device mountable on a wall having an upper, generally horizontal end surface, the wall end surface having a width. The container comprises a generally tubular main body disposeable generally upon the wall end surface, the body having an interior chamber configured to contain at least a portion of a plant and at least one access opening extending into the chamber. The access opening is configured to provide access to the interior chamber and clearance for the plant. Further, the main body has a width substantially equal to the width of the wall end surface.

In another aspect, the present invention is a planter device mountable on a wall having an upper, generally horizontal end surface, the wall end wall surface having a width. The planter device comprises first and second generally tubular main bodies each disposeable upon the wall end surface, each body having an interior chamber configured to contain at least a portion of a separate plant and at least one access opening extending into the chamber. The access opening is configured to provide access to the interior chamber and clearance for the plant and the body has a width substantially equal to the width of the wall end surface. Further, at least one coupler assembly is configured to connect the first and second main bodies and to fluidly couple the interior chambers of the two bodies.

### BRIEF DESCRIPTION OF THE SEVERAL VIEWS OF THE DRAWINGS

The foregoing summary, as well as the detailed description of the preferred embodiments of the present invention, will be better understood when read in conjunction with the appended drawings. For the purpose of illustrating the invention, there is shown in the drawings, which are diagrammatic, embodiments that are presently preferred. It should be understood, however, that the present invention is not limited to the precise arrangements and instrumentalities shown. In the drawings:

FIG. 1 is a top plan view of a planter device in accordance with the present invention;

FIG. 2 is a partly cut-away, side plan view of the planter device;

FIG. 3 is an end view of the planter device;

FIG. 4 is a broken-away, side plan view of coupler assembly;

FIG. 5 is another top plan view of the planter device;

FIG. 6 is a cut-away side plan view of the planter device, showing an air pump and air dispensing system;

FIG. 7 is a top plan view of an alternate construction of a main tubular body having an elongated access opening;

FIG. 8 is a cut-away side plan view of the planter device of FIG. 7, showing an air pump and air dispensing system;

FIG. 9 is more diagrammatic, cut-away end view of the planter device, depicting the flow of air through the vessel interior chamber;

FIG. 10 is an end plan view of the planter device, showing an alternative main body structure;

FIG. 11 is a perspective view of the planter device of FIG. 10;

FIG. 12 is another perspective view of the planter device of FIG. 11, showing an alternative shape and location of the access opening;

FIG. 13 is perspective view of another alternative construction of the planter device main body, the body being formed of two sections;

FIG. 14 is another perspective view of the alternative construction of FIG. 13, depicting an alternative structure of the access opening;

FIG. 15 is an end plan view of an alternative construction of the planter device including an upper dome;

FIG. 16 is an end plan view of an alternative construction of the planter device main body having integral ridges providing distribution passages;

FIG. 17 is partly broken away side plan view of the planter device shown mounted on a wall end surface;

FIG. 18 is an end cross-sectional view of the planter device of FIG. 18;

FIG. 19 is bottom plan view of an end cap of the planter device, showing the mounting holes engageable by headed fasteners;

FIG. 20 is another view of the end cap of FIG. 19, showing an alternative arrangement of the mounting holes;

FIG. 21 is partly broken away side plan view of the planter device shown connected on a wall end surface by means of a mounting bracket;

FIG. 22 is an enlarged side plan view of the bracket of FIG. 21;

FIG. 23 is an end cross-sectional view of the planter device of FIG. 21;

FIG. 24 is bottom plan view of the bracket, showing the mounting holes engageable by headed fasteners;

FIG. 25 is another view of the bracket of FIG. 24, showing an alternative arrangement of the mounting holes;

FIG. 26 is an end plan view of an alternative, two-piece construction of the mounting bracket;

FIG. 27 is a broken-away a top plan view of the bracket of FIG. 26;

FIG. 28 is a perspective view of the mounting bracket of FIG. 26;

FIG. 29 is an end plan view of an alternative construction of an end cap;

FIG. 30 is a partly broken-away side plan view of the alternative end cap of FIG. 29 shown coupled with a tubular main body and a connecting tube;

FIG. 31 is an end plan view of a mounting band that envelopes the tubular body and secures it to the mounting surface;

FIG. 32 is a bottom, enlarged view of a portion of the mounting band of FIG. 31;

FIG. 33 is an end plan view of a yet another alternative construction of an end cap and means to secure it to the mounting surface;

FIG. 34 is a partly broken-away side plan view of the alternative end cap of FIG. 33 shown coupled with a tubular main body and a connecting tube;

FIG. 35 is a side plan view of an alternative means for connecting an end cap to the wall;

FIG. 36 is an end view of the alternative connection means of FIG. 35;

FIG. 37 is a reduced, perspective view of the connection means of FIG. 35;

FIG. 38 is a side plan view of another alternative means for mounting the planter device to the wall;

FIG. 39 is an end plan view of the connection means of FIG. 38;

FIG. 40 is an end plan view of another alternative means for connecting an end cap with the wall;

FIG. 41 is an end plan view of a means for connecting the tubular body directly to the wall;

FIG. 42 is an end plan view of an alternative mounting bracket for connecting the planter device to the wall;

FIG. 43 is a side plan view of the planter device, showing components of a nutrient dispenser system;

FIG. 44 is a top plan view of the nutrient system configured to supply a network of tubular main bodies;

FIG. 45 another side plan view of the planter device, showing a drainage means for a passive system;

FIG. 46 is a top plan view of a plant support member;

FIG. 47 is a side plan view of the plant support member, shown coupled with the tubular main body;

FIG. 48 is side plan view of the plant support member, shown in a first, lowermost position with respect to the main body;

FIG. 49 is side plan view of the plant support member, shown in a second, middle position with respect to the main body;

FIG. 50 is side plan view of the plant support member, shown in a third, uppermost position with respect to the main body;

FIG. 51 is a side plan view of the planter device shown with three plant support members;

FIG. 52 is an unwrapped view of a plant support member

FIG. 53 is a side plan view of the planter device of FIG. 52; and

FIG. 54 is side plan view of the planter device with a plurality of alternative plant support members.

FIG. 55 is perspective plan view of a plant support member that is installed between the pot and opening in the tubular body

### DETAILED DESCRIPTION OF THE INVENTION

Certain terminology is used in the following description for convenience only and is not limiting. The words “right”, left”, “lower”, “upper”, “upward”, “down” and “downward” designate directions in the drawings to which reference is made. The words “inner”, “inwardly” and “outer”, “outwardly” refer to directions toward and away from, respectively, a designated centerline or a geometric center of an element being described, the particular meaning being readily apparent from the context of the description. Further, as used herein, the word “connected” is intended to include direct connections between two members without any other members interposed therebetween and indirect connections between members in which one or more other members are interposed therebetween. The terminology includes the words specifically mentioned above, derivatives thereof, and words of similar import.

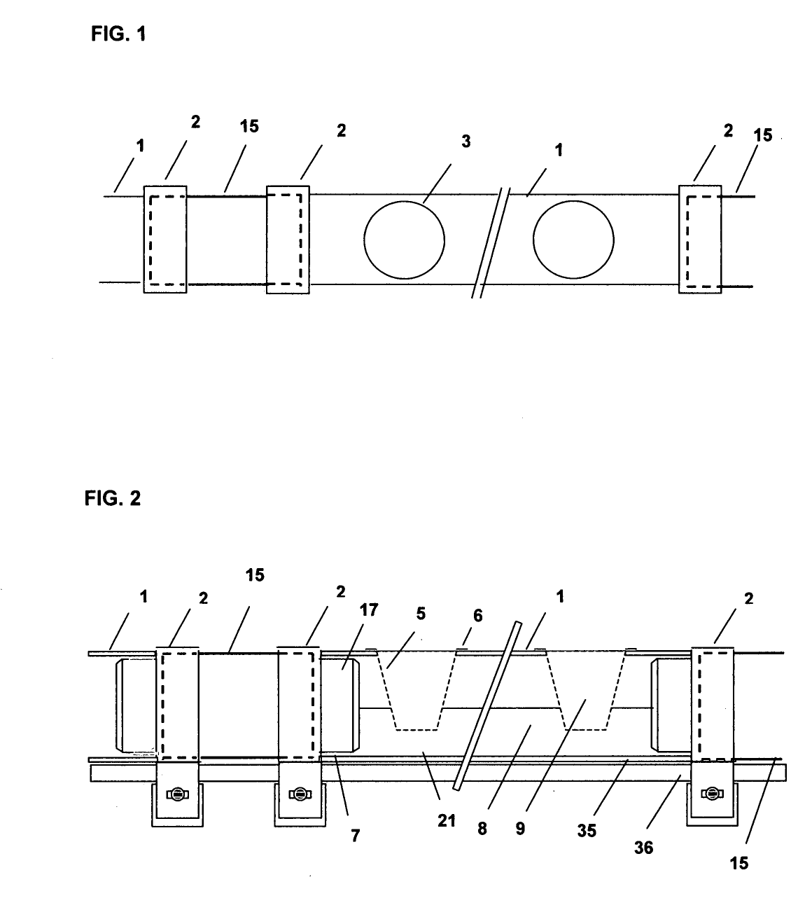

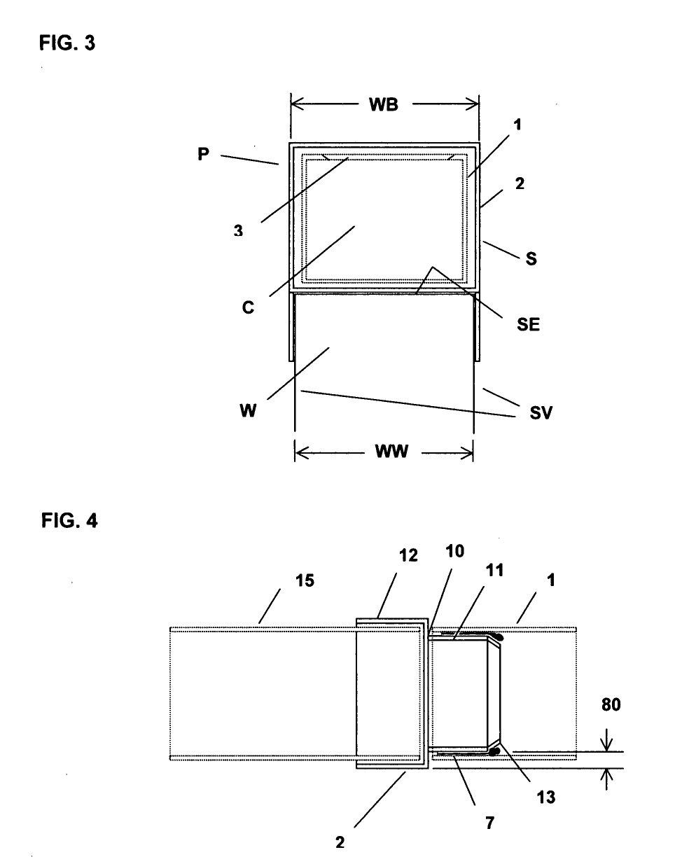

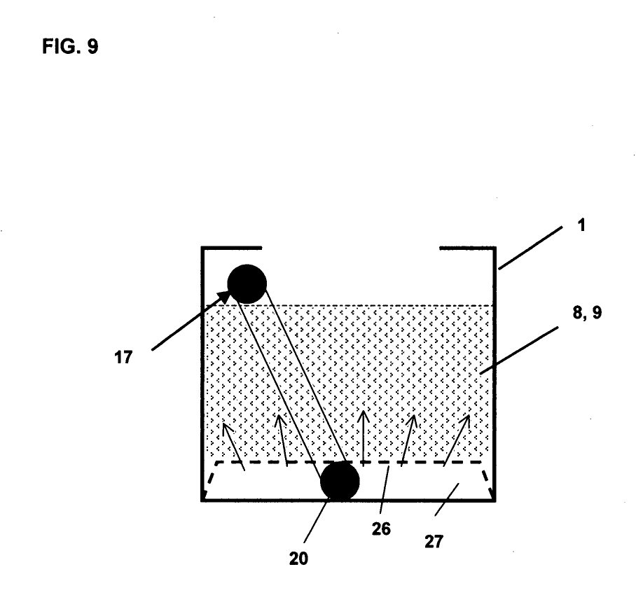

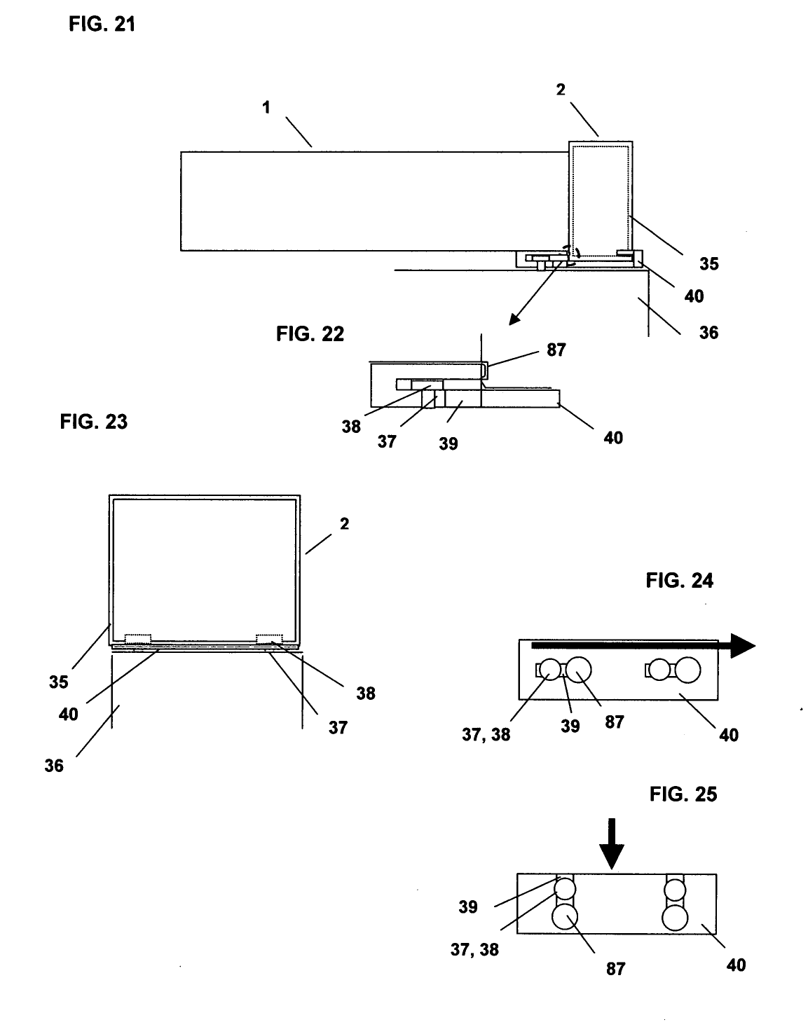

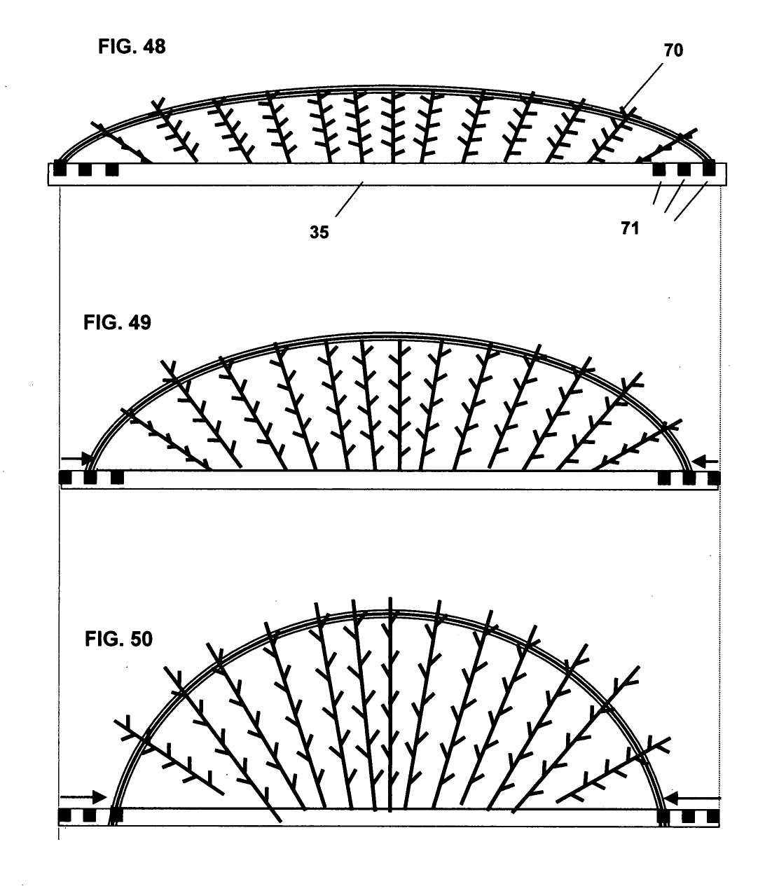

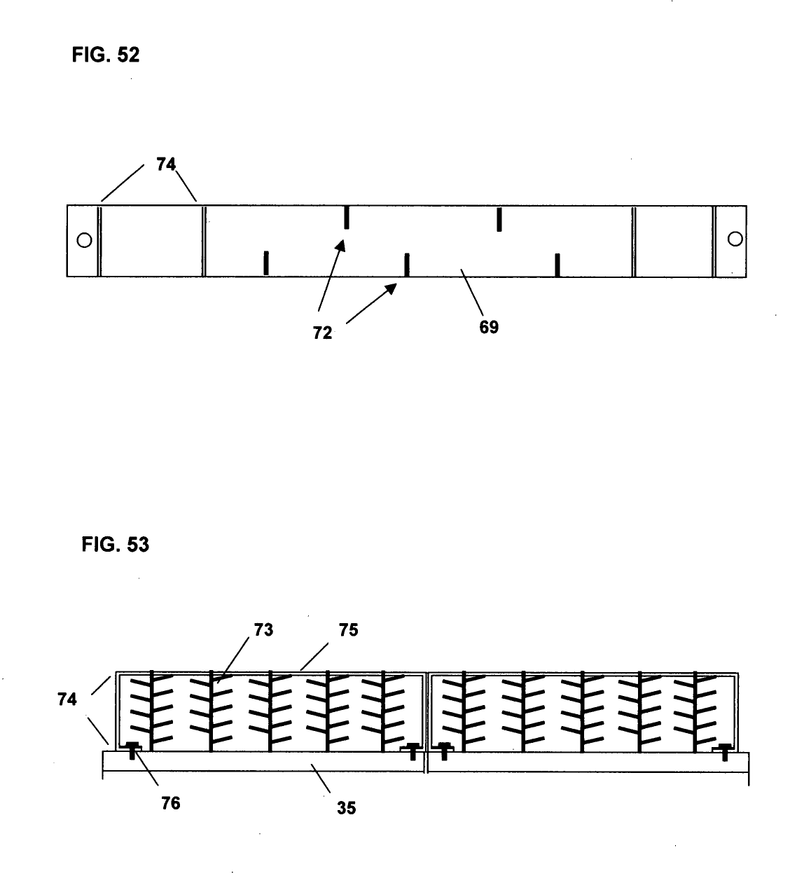

Referring now to the drawings in detail, wherein like numbers are used to indicate like elements throughout, there is shown in FIGS. 1-55. As depicted in FIG. 3, the present invention most generally consists of a planter device P mountable on a wall W having an upper, generally horizontal end surface SE and opposing generally vertical surfaces SV, the wall end surface SE having a width WW. The planter device basically comprises a generally tubular main body 1 disposeable generally upon the wall end surface SE. The body 1 has an interior chamber C configured to contain at least a portion of a plant, at least one access opening 3 extending into the chamber C, and opposing side surfaces SB. The access opening 3 is configured to provide access to the interior chamber C and clearance for the plant. Further, the main body 1 has a width WB substantially equal to the width WW of the wall end surface SE and the main body 1 is sized such that each body side surface SB is generally flush with a separate one of the wall vertical surfaces SV when the body 1 is disposed on the wall end surface SE.

Preferably, the planter device is an active hydroponic growing system utilizing a continuous supply of pressurized air. Two such planter designs are disclosed. The first design utilizes growth medium which is contained in pots which are suspended in the tubular vessel. The nutrient solution into which the pots extend is aerated by the pressurized air. The second design utilizes growth medium that is inserted directly in the vessel and placed on top of a mesh or perforated panel. Pressurized air is introduced into the cavity beneath the mesh or perforated panel and permeates the growth medium with oxygen.

### Basic Construction of Planter

For the purpose of conveying the basic design concepts and specific features of the subject invention, reference will now be made to the embodiments illustrated in the sketches contained herein using a consistent numbering scheme. To promote clarity, some features have been omitted from the figures so that focus can be given to the specific features that are being described.

The figures generally depict planters mounted on office partitions although the designs described herein are equally applicable to any horizontal mounting surface including office partitions, movable walls, narrow ledges and window sills.

Referring to FIGS. 1 & 2, the tubular main body 1 is preferably of uniform cross section and contains access openings 3 in the top surface which accommodate a plurality of small containers or pots 5 which contain growth medium 9. The pots 5 have an outer rim or lip 6 which is slightly larger than the opening into which they fit that suspends them above the bottom of the tubular body 1. End caps 2 enclose the tubular body 1 at each end. They may be integral with the tubular body 1 or separable and affix to the tubular body 1 through use of an adhesive/sealant or gasket 7.

FIGS. 3 & 4 shows a separable end cap 2 including of a wall 10 that is perpendicular to the longitudinal axis, an interior extension 11 and an exterior extension 12. The interior extension 11 includes a first generally enclosed wall disposeable within the tubular body 1 and the exterior extension 12 includes a second, generally enclosed wall connected with and spaced radially outwardly from the first wall and configured to receive a portion of a connecting tube 15 which has the same cross sectional profile as the tubular body 1. The interior extension 11 and exterior extension 12 of the end cap 2 are laterally offset 80 such that the interior extension 11 fits inside the tubular body 1 and the exterior extension 12 fits outside the connecting tube 15. The interior extension 11 contains an inward oriented beveled edge 13 to aid in alignment during assembly. The beveled edge 13 also collects the adhesive/sealant 7 during assembly and spreads it uniformly between the contact surfaces.

The connecting tube 15 fits snugly into the end caps 2 to connect adjoining units to provide continuity in appearance. Construction of the connecting tube 15 can take the form of a straight connector, elbow or ‘T’ section positioned at corners and junction points of the mounting surfaces.

Referring again to FIG. 1, the vessel is partially filled with a nutrient solution 8 that supports plant growth. The planter 35 is fastened to the mounting surface 36 at each end. The modular construction enables this planter to be one of many in a continuous network.

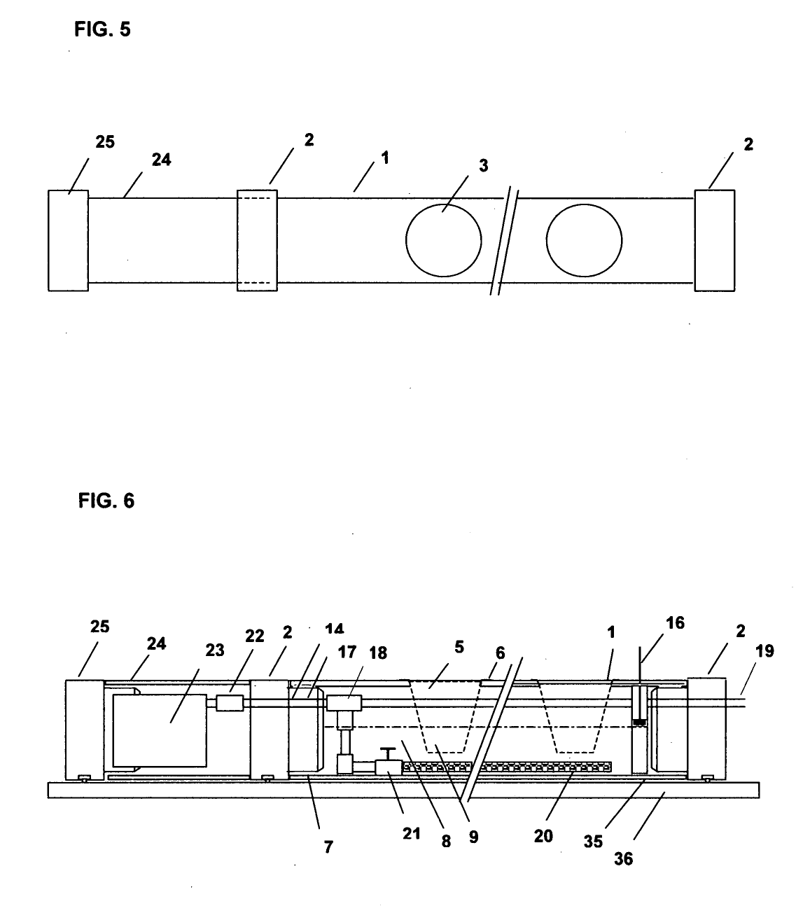

FIGS. 5 & 6 shows an active hydroponic system with an air pump to aerate the nutrient solution. It consists of the basic design previously described with the following additional features. The pots 5 used are called “net pots” which are commonly used in hydroponic systems. Net pots contain large gaps in the side(s) and bottom through which roots can pass to access the nutrient solution 8. Round, square or rectangular pots 5 may also be used which require correspondingly shaped openings 3 in the tubular body 1. A water level indicator 16 is placed in the solution to provide an external means of visually determining water level.

Preferably, an air pump 23 is used to provide pressurized air to the unit. At least one air line 17 extends from the air pump 23 and through a hole 14 in the end cap 2 and branches off in two directions through a ‘T’ connector 18. One branch, termed ‘through-flow air line’ 19 extends through the length of the tubular body 1 and passes through the end cap 2 at the far end. It provides pressurized air to successive planters in the network thus allowing a single source of pressurized air to supply multiple planters. The second branch connects, through means of an elbow, to the aeration tube 20. The aeration tube 20 is positioned at the bottom of the planter and traverses the length of the tubular body 1. It consists of perforated or porous tubing or a series of air stones typically used in aquariums. The purpose of the aeration tube 20 is to generate air bubbles to oxygenate the solution. It is desirable to select an aeration tube 20 that generates very fine air bubbles so that a greatest amount of oxygen can be imparted to the solution with the smallest possible air supply. A flow control valve 21 is placed between the ‘T’ connector 18 and aeration tube 20. It is adjusted to regulate the flow rate of air passing through the aeration tube 20 and, indirectly, through the through-flow air line 19 that connects to the downstream units in the network. A check valve 22 is placed between the air pump 23 and air supply line 17 to prevent the migration of water into the air pump 23. For units with integral air supplies, the air pump 23 is contained in a separate section of tube adjacent to the planter termed ‘air pump retaining tube’ 24. It consists of a length of tube with the same cross sectional profile as the plant containing vessel and fits snugly inside the end cap 2. An end cover 25 is placed on the free end of the air pump retaining tube 24 which contains large passages in the side wall that provide an unobstructed flow of cool air to the air pump. The electrical cord of the air pump passes through a grommet placed in a hole in the wall of the retaining tube and is connected to an electrical outlet. If the noise of the air pump becomes bothersome to the occupants, the pump can be connected to a timer which activates the pump during hours when the room is not occupied.

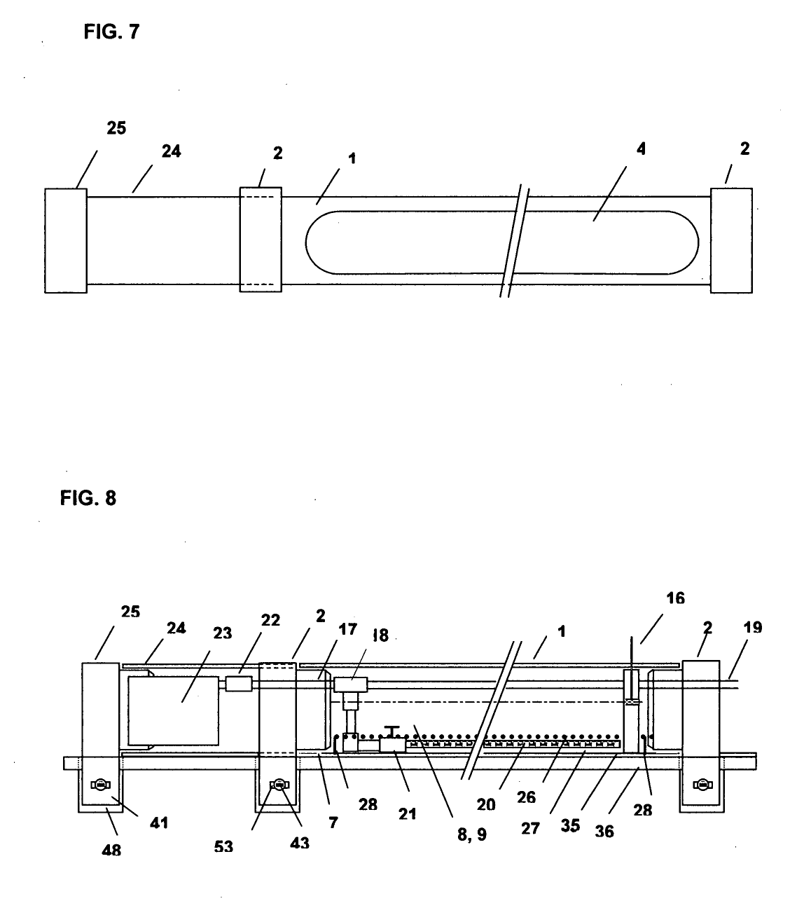

FIGS. 7 & 8 shows an active hydroponic system similar to the potted design shown in FIGS. 5 & 6 but with the following differences. The tubular body 1 contains one or more elongated openings 4 in the top surface into which growth medium 9 is placed. Growth medium 9 is placed on a perforated panel or mesh 26 which sets on the bottom of the vessel. The perforated panel or mesh 26 sets above the bottom surface of the vessel forming a cavity 27 beneath the growth medium 9 sufficiently wide to accommodate the aeration tube 20. End seals 28 are positioned at each end of the cavity 27 to trap the air inside the cavity 27. FIG. 9 illustrates the way in which air accumulates in the cavity 27 forming an air pocket which imparts oxygen to the boundary layer and forces air through the perforated panel or mesh 26 and into the nutrient solution 8 and growth medium 9. A variation of this scheme involves connecting the air pump 23 to a timer which activates at regular time intervals. As air is introduced into the cavity 27 formed by the perforated panel or mesh 26, it displaces nutrient solution 8 into the upper regions of the planter. When the pump turns off and the air pocket within the cavity 27 dissipates, the nutrient solution 8 drains into the cavity 27 in the low region of the planter and fresh air is drawn into the growth medium 9 from the top surface.

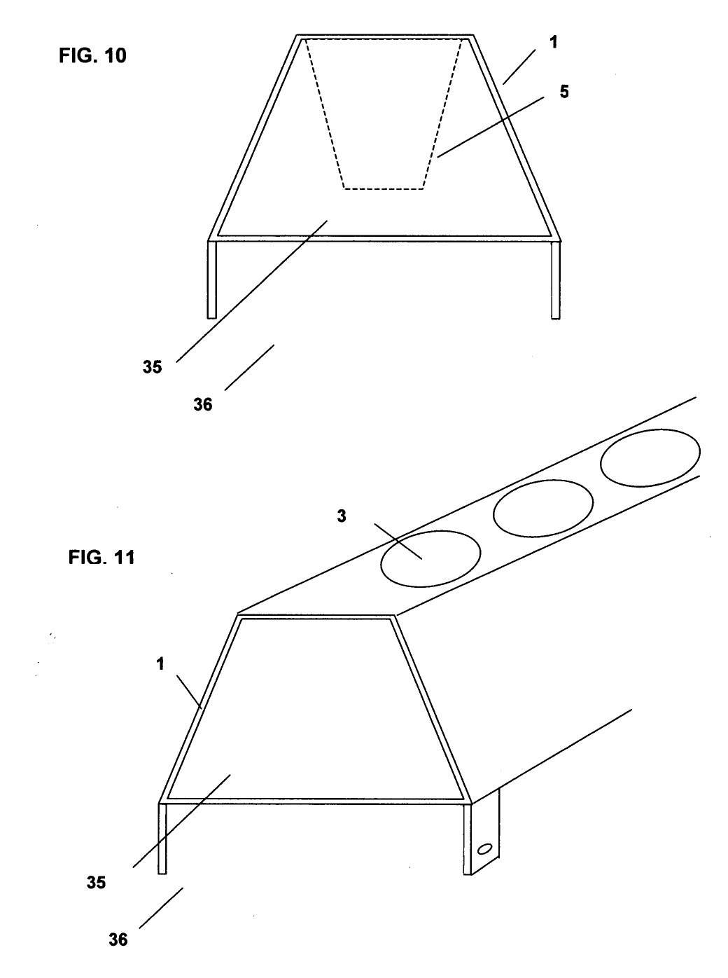

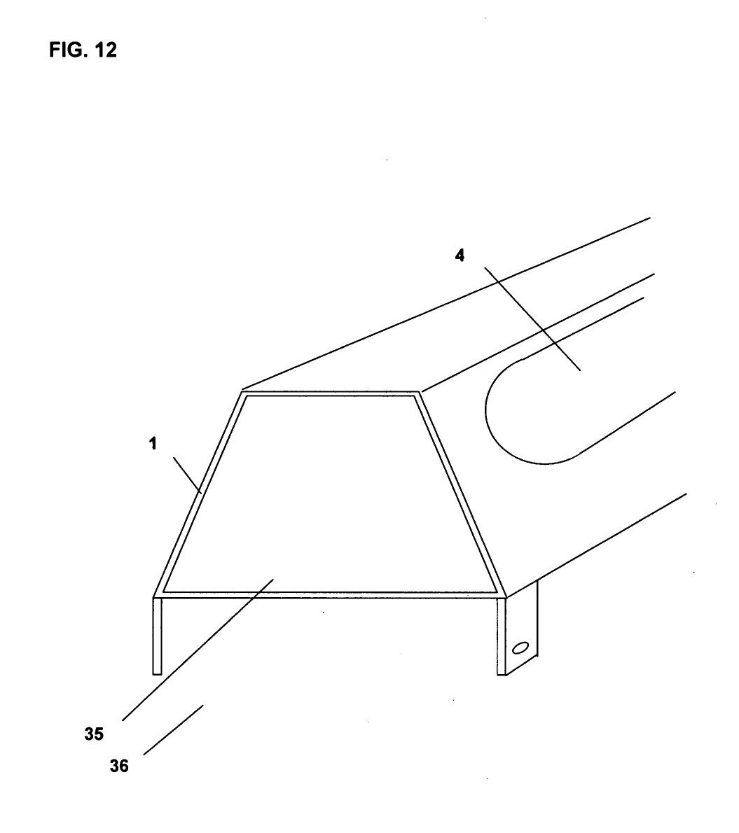

The cross section of the tubular body may be take the form of any enclosed shape. For example, FIGS. 10 & 11 shows a tubular body 1 with a trapazoidal cross section with pots 5 suspended from the top surface. FIG. 12 shows a tubular body 1 with a trapazoidal cross section with openings 4 for the plants extending out from both sides. This design is particularly suited for plants with hanging vines.

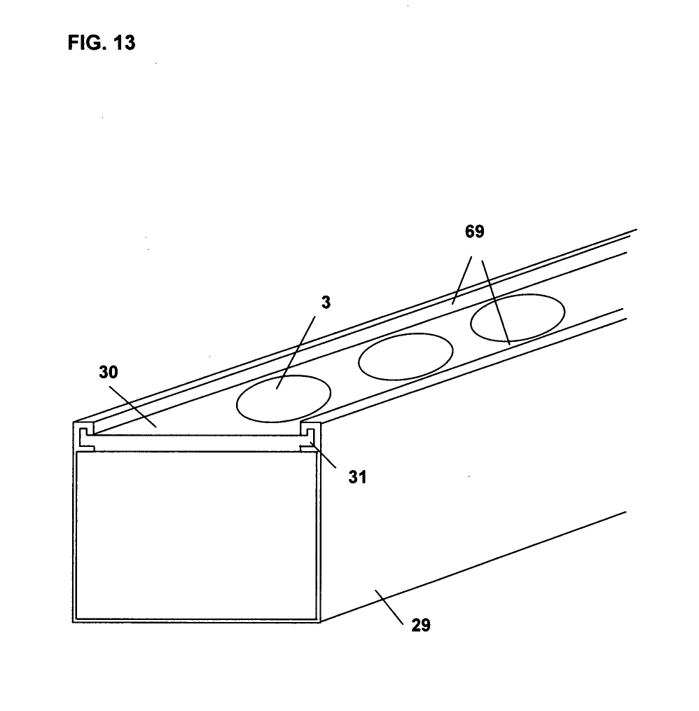

The tubular body 1 can be constructed of two parts as shown in FIG. 13. The lower portion 29 forms the bottom and sides and a top portion 30 contains the openings 3 that accommodate the plants. The two portions are joined by an interlocking slot arrangement 31 which requires the parts to be assembled longitudinally.

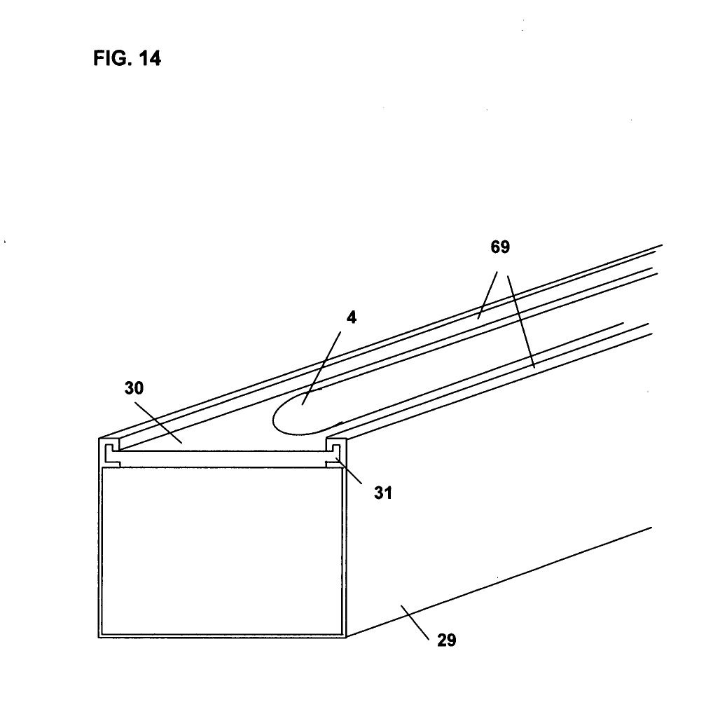

FIG. 14 shows similar construction as FIG. 14 but containing one or more longitudinal slots into which growth medium and plants are placed.

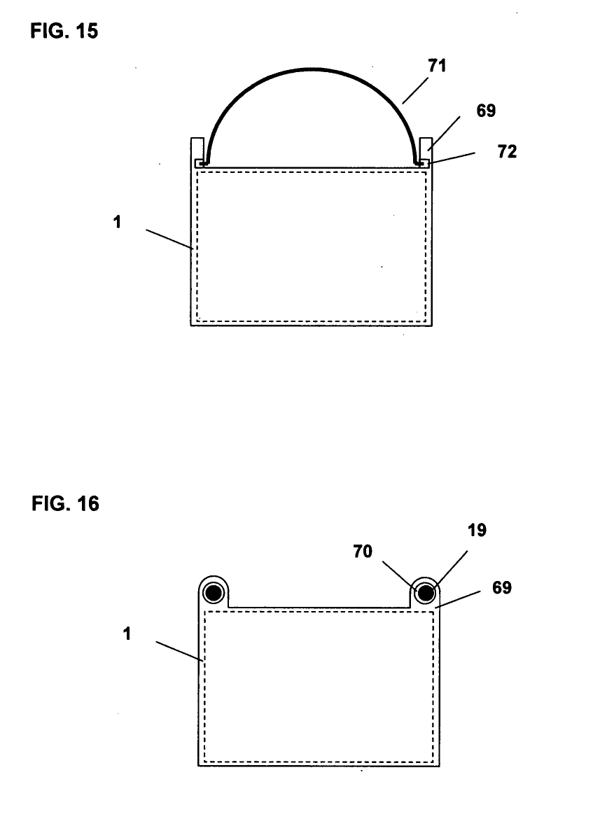

FIG. 15 shows longitudinal ridges 69 placed along the top edges of the tubular body 1 which form a barrier to prevent spillage when filling and to contain the nutrient solution 8 in the event the planter is overfilled. A dome 71 constructed from a transparent material such as clear plastic or plexiglass may be placed on top of the planter to retain moisture. The longitudinal ridges 69 that run along top edges of the tubular body 1 contain slots 72 which retain the dome.

FIG. 16 shows these longitudinal ridges 69 placed along the top edges of the tubular body 1 containing hollow 70 passages that accommodate distribution tubing 19 that pass through the planter.

### Mounting Methods

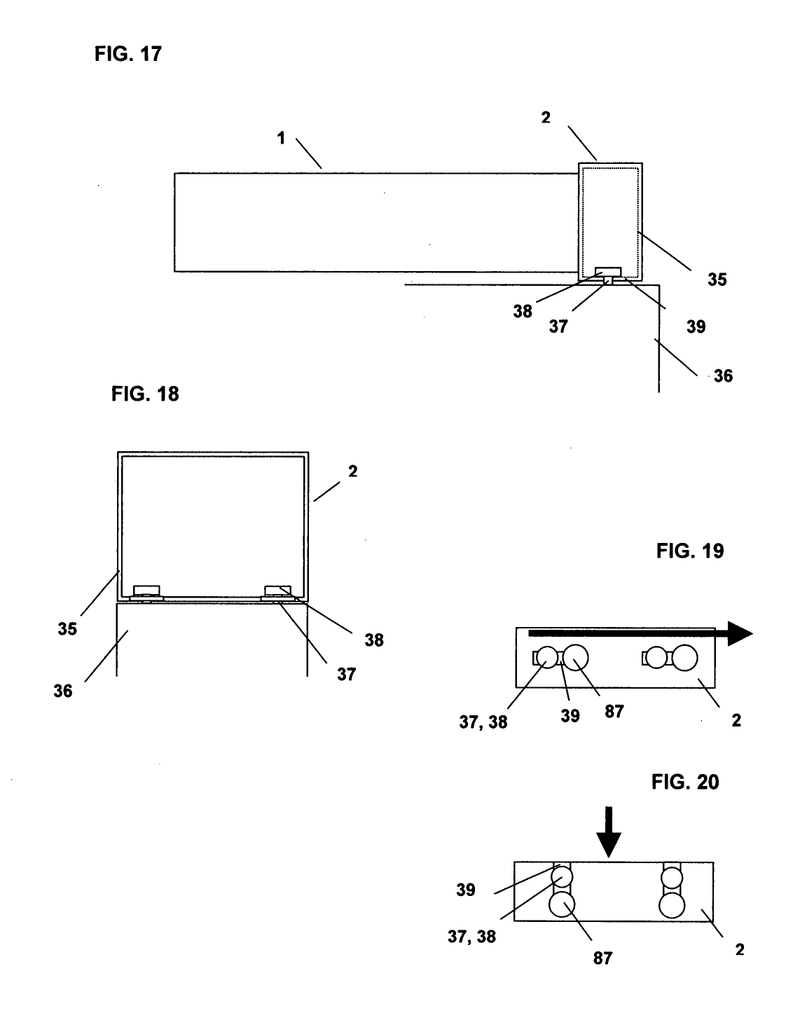

FIGS. 17-42 depicts various means to attach the planter 35 to the mounting surface 36.

FIGS. 17-25 depicts a means of attachment that is accomplished through the use of rivets 37 with exposed heads 38 which extend out from the top of the mounting surface 36 and engage mating holes 87 and slots 39 in the planter as illustrated in these figures. Riveted connections are positioned at each end of the planter 35 to fully constrain it. FIGS. 17-20 shows this arrangement where the holes 87 and slots 39 are incorporated into the lower portion of the end cap 2. FIGS. 21-25 shows a separable bracket 40 with a “snap on” fit 87 that is retained by the end cap 2. The separable bracket contains holes 87 slots 39 that engage the rivets. In both instances, the slots 39 can be oriented either laterally or longitudinally with respect to the mounting surface. Longitudinally oriented slots makes the unit less likely to disengage when accidentally bumped although it is more difficult to mount as compared with slots that are oriented laterally. A similar arrangement can be used where the slots are incorporated into the mounting surface and rivets are incorporated into the planter or a separable bracket.

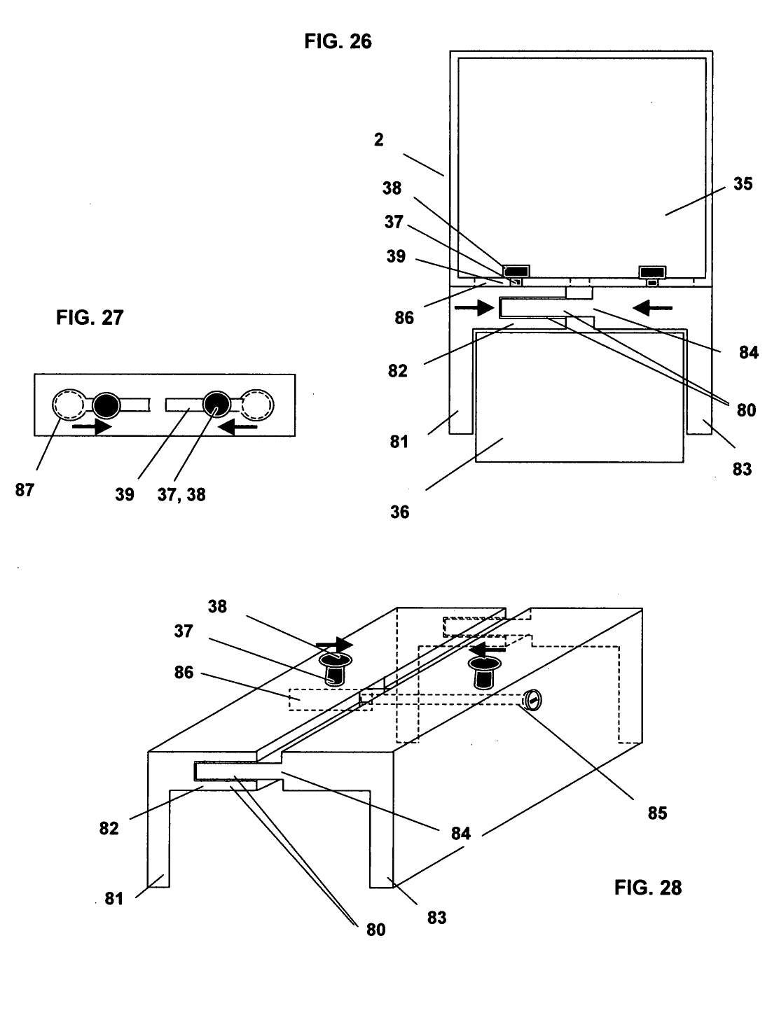

FIGS. 26-28 depicts a similar means of attachment that employs a mounting bracket 80 having rivets 37 with exposed heads 38 which engage mating holes 87 and slots 39 in the end cap. The mounting bracket 80 consists of two parts 81 & 83 that have an engaging mating connection 82 & 84 that serve to preclude rotation in the installed condition. A threaded fastener 85 is positioned in one of the brackets and engages a threaded hole in the mating bracket. The end cap contains two holes 87 and slots 39 which engage the rivets in the bracket. The diameter of the holes 87 is slightly larger than the rivet heads 38 and the width of the slots 39 is slightly wider than the width of the stem of the rivet 37. Assembly consists of placing the planter 35 onto the mounting bracket 80 such that the rivets 37 pass through the holes 87 in the end cap. As the fastener 85 is tightened, the rivets 37 advance through the slots 39 and draws the planter down on to the mounting bracket 80, while at the same time, the bracket 80 clamps to the partition 36. A similar arrangement can be used where the slots are incorporated into the mounting bracket 80 and rivets 37 are incorporated into the planter 35.

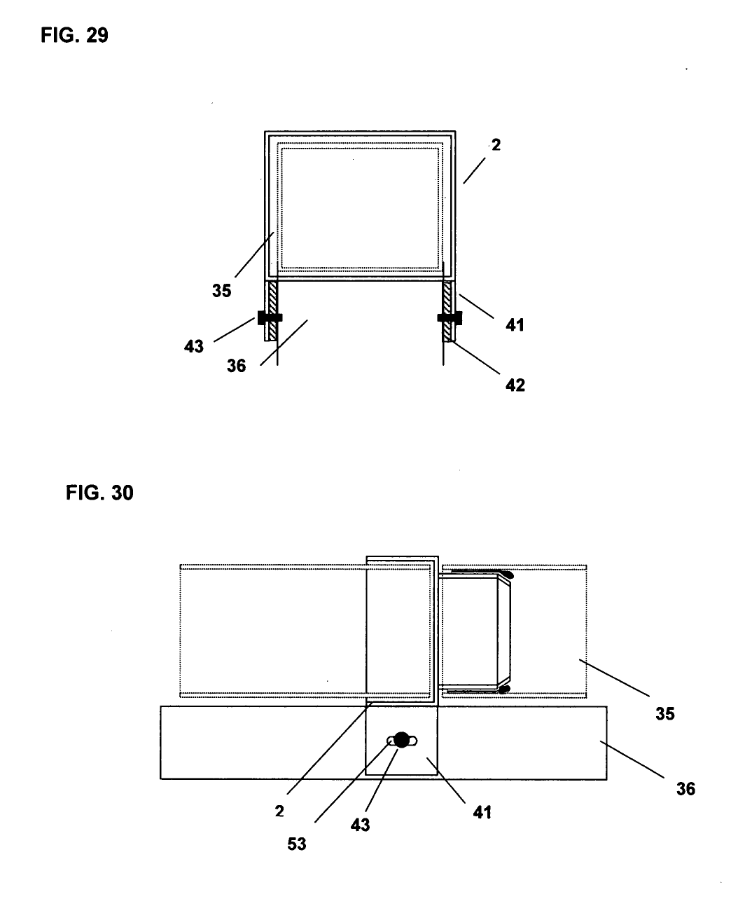

When no special means of attachment are provided by the partition, attachment can be achieved by utilizing features that commonly exist in commercially available office partitions. FIGS. 29 & 30 show one such means of attachment which utilizes mounting tabs 41 which extend vertically downward from the end caps and are secured to the mounting surface 36 by fasteners 43. An optional shim 42 may be used to accommodate any difference in width between the mounting tabs and mounting surface. The mounting tabs 41 can either be made integral with the end cap 2 or separable and affixed to the end caps 2.

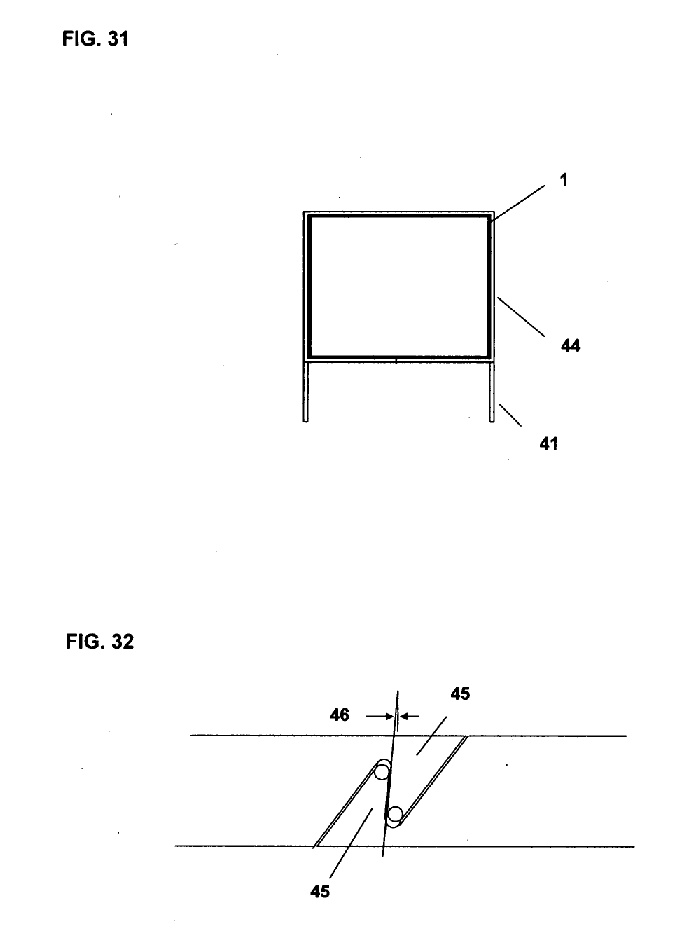

FIG. 31 shows mounting tabs 41 incorporated into a mounting band 44. The mounting band 44 envelopes the tubular body 1 and has interlocking tabs 45 that fasten the ends together. FIG. 32 shows a bottom, expanded view of the interlocking tabs where line of contact of the tabs is inclined a small negative angle 46 to promote locking after the tabs snap together. The mounting band 44 conforms to the outer surface of the tubular body 1 and forms a snug fit with the tubular body 1. The mounting bands 44 has the advantage that it can be placed at designated locations along the length of the tubular bodies 1 whereas mounting tabs that are incorporated into the end caps 2 require that the mounting tabs at the ends of the planter align with designated points of attachment on the mounting structure.

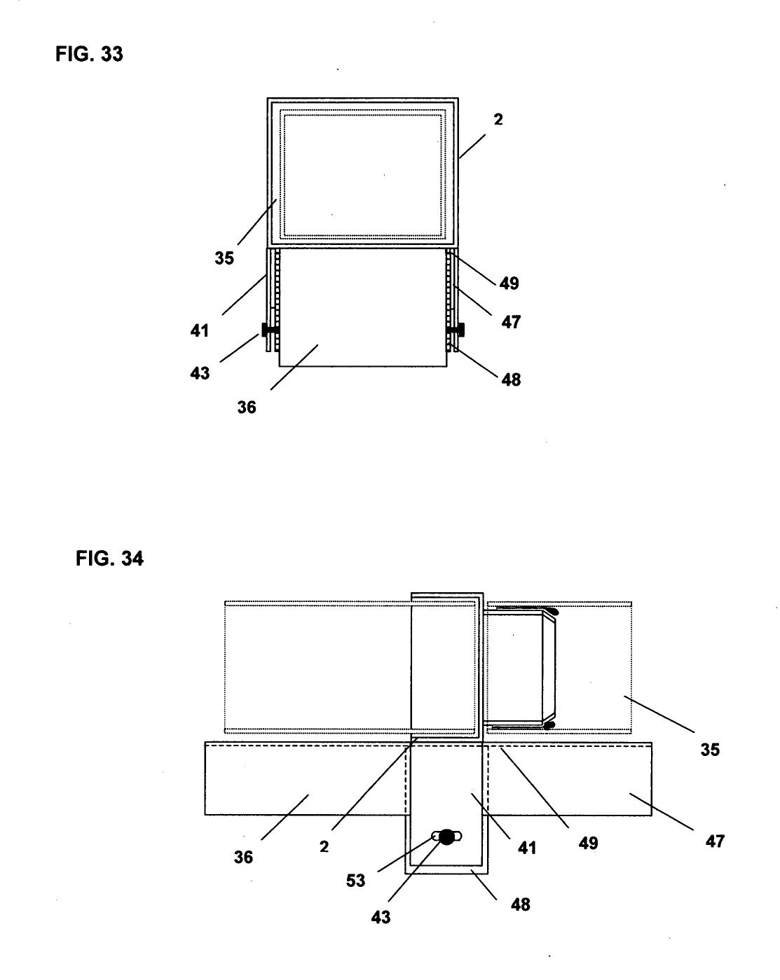

FIGS. 33 & 34 depicts an attachment method which can be used if the mounting surface possesses a horizontal metal rim or lip 47 along side the mounting surface at top edge. A tab insert 48 is tucked between the wall and metal rim 47 until it contacts the inside top edge of the rim 49. The planter 35 is placed on the partition 36 so that the mounting tab 41 aligns with the tab insert 48 and the two tabs are connected together using a small fastener 43. The length of the fastener is chosen such that it passes through the mounting tab 41 and tab insert 48 but does not extend a significant distance through the tab insert 48 to preclude damage to the mounting surface 36. This is a versatile mounting method since the attachment points can exist anywhere along the length of the mounting surface 36.

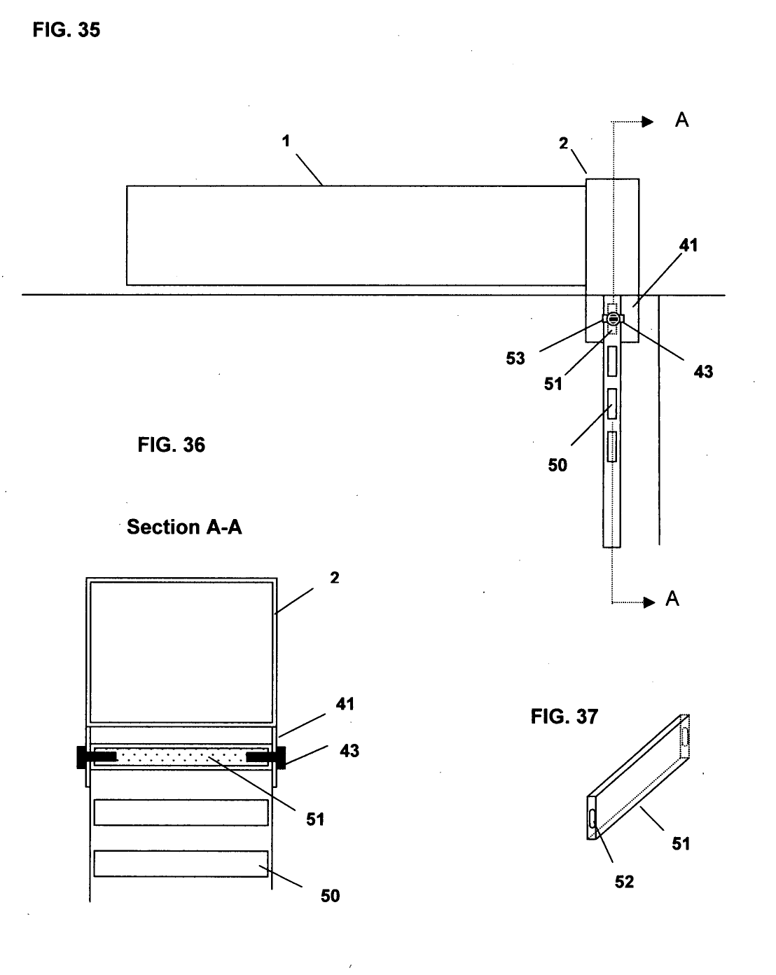

FIGS. 35-37 depicts an attachment method which can be used if an office partition possesses a vertical row of metal slots 50 at each edge of the partition which are commonly provided to fasten bookshelves to the partition. An insert strip 51 is used whose width and height are slightly less than that of the slot 50 and with a length corresponding to the width of the partition wall. The insert strip is tapped into one of the slots 50 at each side of the partition. A fastener 43 is then inserted through an opening 53 in the mounting tab 41 which engages a slightly smaller hole or vertical slit 52 placed through the insert strip 51 and secured into place. As the fastener 43 advances through the slit 52, it expands the insert strip 51 to securely fasten it inside the slot of the partition 50. The fastener 43 can be threaded, such as a screw or non-threaded, such as a tapered pin. This method of attachment requires that the planters be of comparable length such that the mounting tabs align with the slots 50 in the edge of the partitions. Horizontal slots 53 can be placed in the mounting tabs to provide a small adjustment capability when aligning the mounting tabs 41 over the insert strips 51 to account for slight manufacturing and assembly variations.

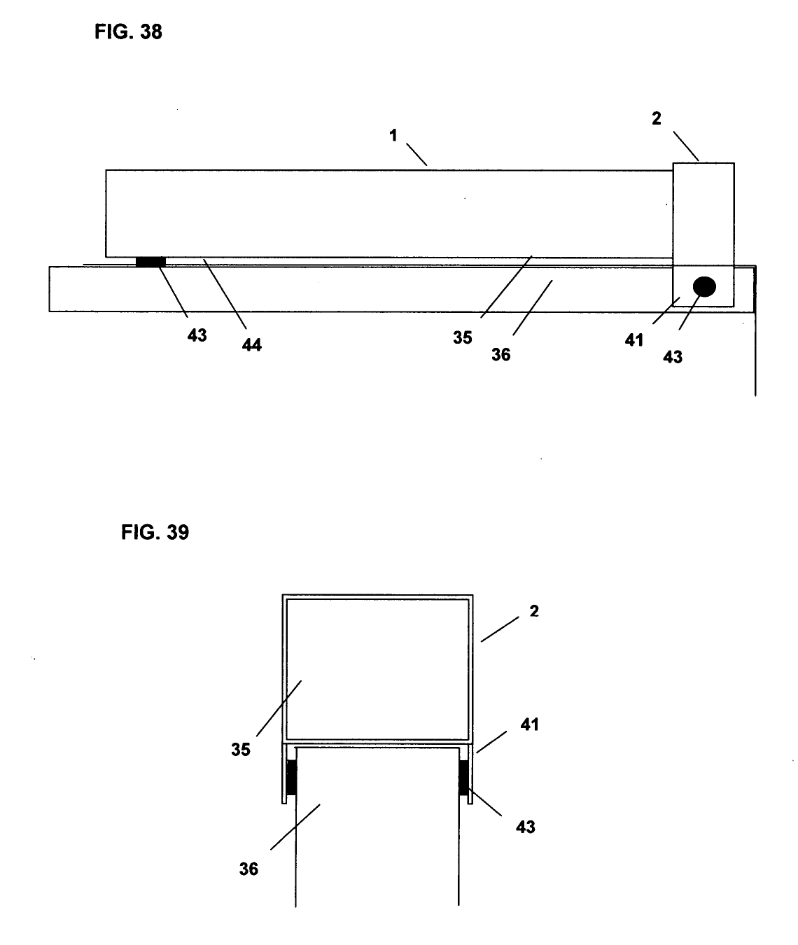

FIGS. 38 & 39 depicts a general attachment means that is accomplished through the use of common fastening devices 43 such as threaded fasteners, magnets, Velcro, snaps or adhesive strips. In the case of magnets, Velcro, snaps or adhesive strips, they can be attached to the mounting tabs 41 or to the underside surface of the planter 44. For fabric covered partitions with cardboard or chipboard (interior) frames, staples or tacks may also be used. They must be sufficiently long to engage the inner frame to firmly secure the planter in place.

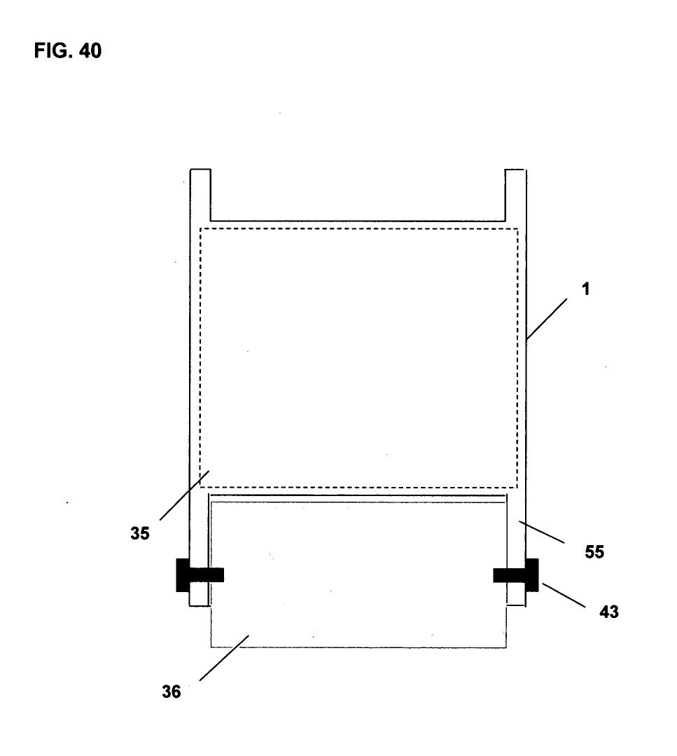

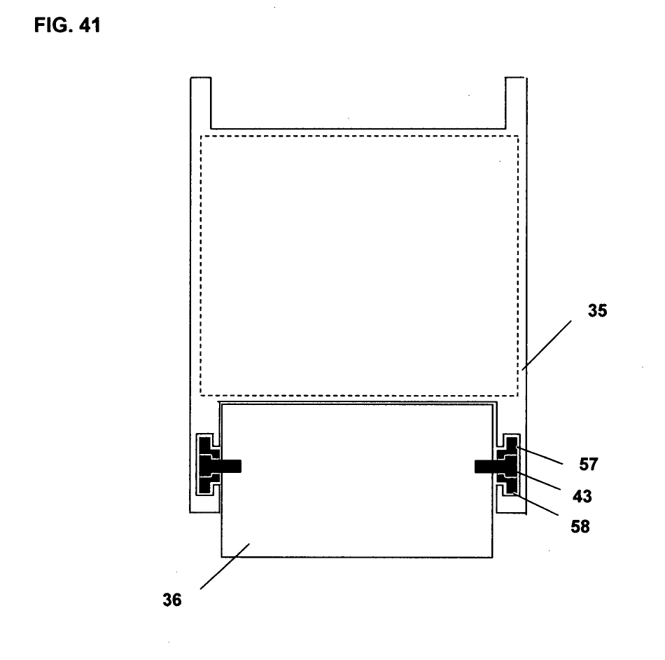

FIG. 40 shows the tubular body 1 with longitudinal projections 55 that extend out the bottom surface at each edge. These projections 55 can be used to fasten the planter 35 to the mounting surface 36 with fasteners 43.

FIG. 41 shows a mounting bracket 57 which can be used to fasten the planter 35 to the mounting surface 36. The mounting bracket is secured to the mounting surface through the use of a fastening device 43. A projection in the mounting bracket engages a slot of corresponding geometry in the planter which joins the two members. The use of mounting brackets allows removal of the planter without disturbing the connection between the mounting bracket 57 and mounting surface 36.

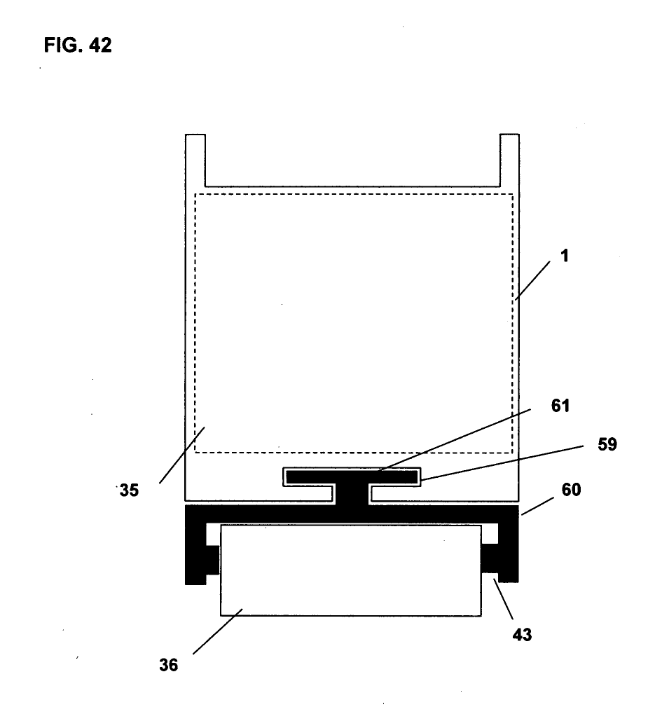

FIG. 42 shows the tubular body 1 with a ‘T’ slot 59 incorporated beneath the planter 35. Mounting brackets 60 with a corresponding ‘T’ slot geometry 61 are inserted into the ‘T’ slot 59 and clocked 90 degrees to them lock them in place. The mounting bracket 60 is secured to the mounting surface 36 through means previously described 43. Placing a slight taper in the ‘T’ slot profile may facilitate assembly.

### Alternate Growing Methods

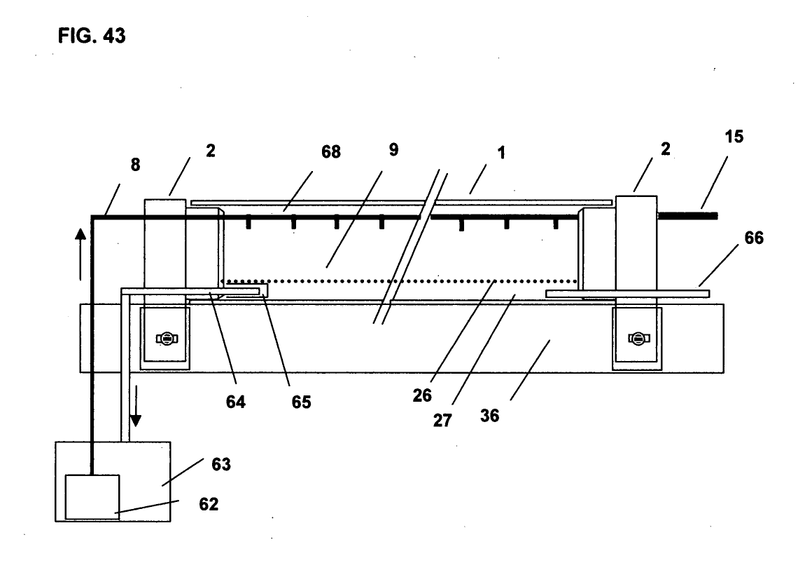

The active growing methods describe thus far involved aerating the nutrient solution 8 with pressurized air. FIG. 43 shows another active growing system wherein nutrient solution 8 is pumped into a distribution line 68 positioned at the top of the growth medium 9 and dispenses nutrient solution which free-drains into a cavity at the bottom of the planter 27 and into a drain line 64 that leads back to a reservoir 63. The drain system is designed such that the growth medium 9 retains only the amount of solution that is can freely absorb. The drain line in the bottom of the planter 64 has a filter 65 to prevent debris from blocking the line. An optional ‘through-flow’ drain line 66 enters from the opposite end of the planter which contains drain water from other planters in the network. The pump 62 and reservoir 63 for both of these active systems can either be integral with the planter or external to the planter.

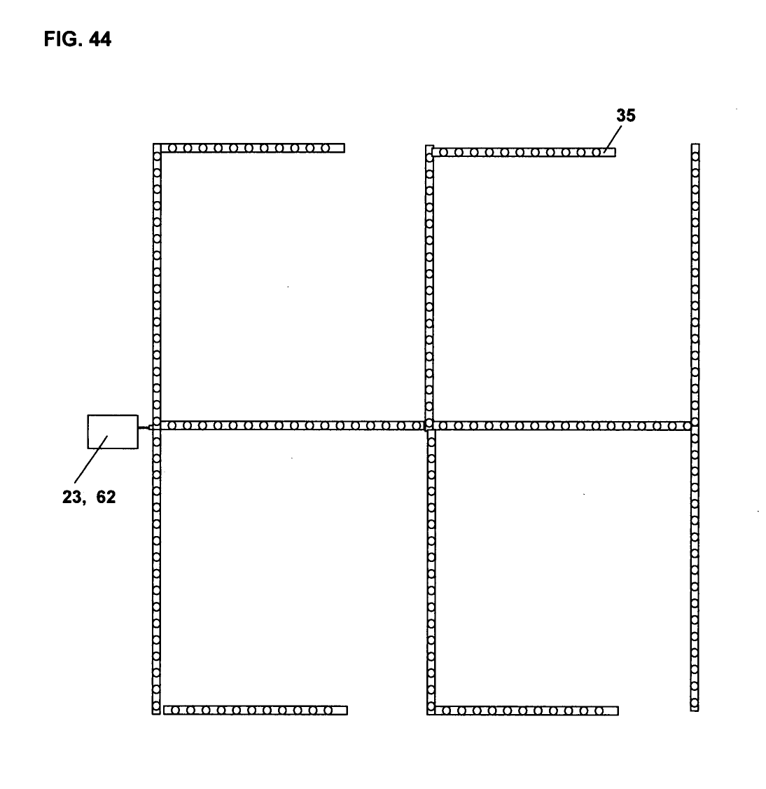

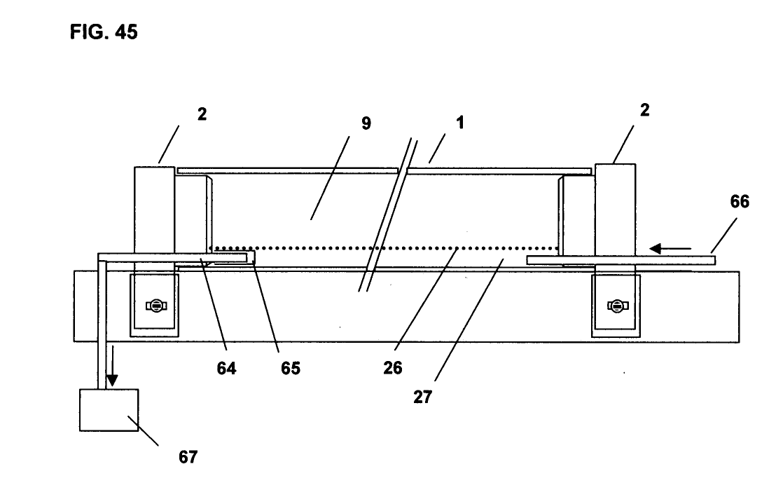

For active growing systems utilizing air pumps or liquid pumps where a number of planters are in close proximity with one another, they may be networked together and share the same pump 23/62 and reservoir 63 (if applicable). This is illustrated in FIG. 44.

FIG. 45 depicts a passive system which is simpler in construction than active systems as they do not require pumps, timers, reservoirs or distribution systems. Nutrient solution is manually poured into the top of the planter and free-drains into a drainage cavity 27 positioned in the bottom of the planter. An optional drain line 64 may be used to drain excess solution from the planter into a collection vessel 67. The drain line in the bottom of the planter has a filter 65 to prevent debris from blocking the line. An optional ‘through-flow’ drain line 66 enters from the opposite end of the planter which contains drain water from other planters in the network.

### Means of Supporting Plant Stems

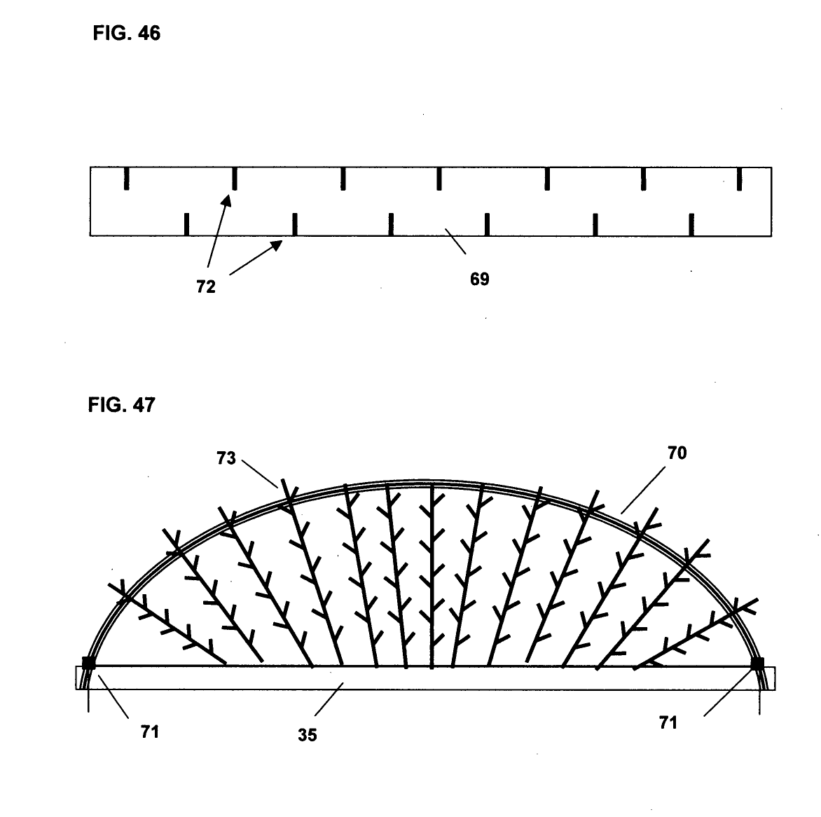

FIGS. 46-55 depict various means to provide structural support to plants 73 with vine-type stems such as ivy, philodendron and pothos.

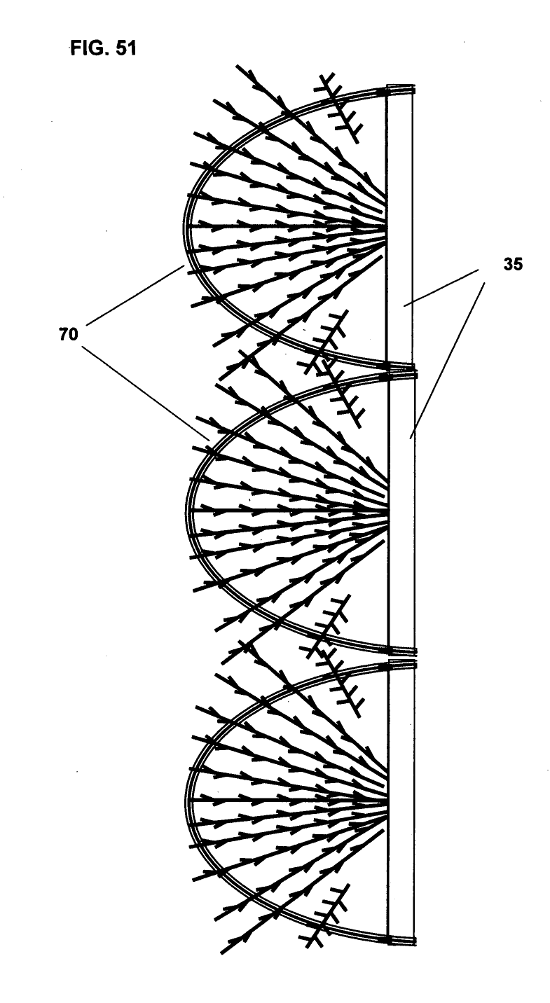

FIGS. 46 & 47 shows one such means which consists of a slender member made from such materials as acrylic, plastic, vinyl and wood that is formed in the shape of an arch 70 and secured to the planter 35 at the end points 71. Arches are highly stable structures and can extend a significant height above the surface with little or no lateral support. Slots 72 are cut partially through the strip in an alternating fashion. The plant stems 73 are inserted into the slots. By alternating the slots 72 along the length of the arch 70, the plant stems 73 provide lateral support to the arch by constraining it on both sides. In this way, the arch 70 supports the plants 73 and the plants 73, in turn, stabilize the arch 70. As the plants 73 grow in length, provision can be made to move the arch end supports 71 closer together to increase the center height as illustrated in FIGS. 48-50.

An alternative is to fix the location of the end supports 71 and use progressively longer strips 69 to increase the height of the arch. FIG. 51 shows arches 70 on adjoining planters 35 resulting in an aesthetically pleasing appearance, particularly along corridors.

FIGS. 52 & 53 illustrates a similar support structure 75 wherein the slender member 69 which contains alternating slots possesses a number of bends 74 in the manner shown in the figures with the center section that is aligned parallel with the mounting surface 35. This support structure 75 is fastened 76 to the planter 35 at each end.

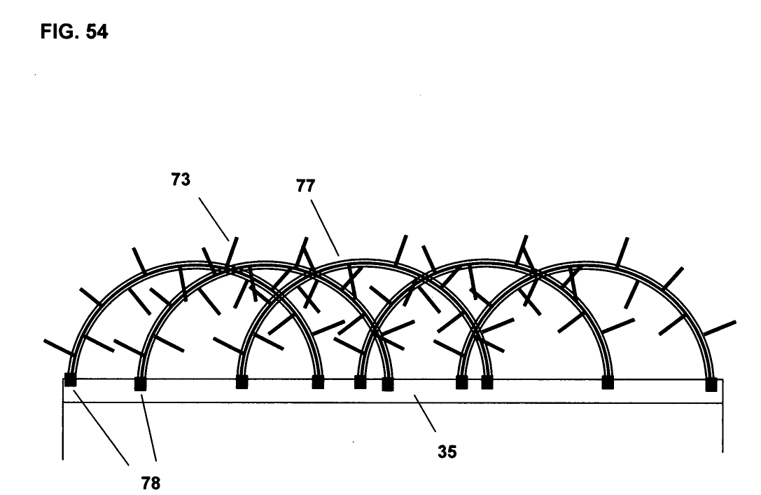

FIG. 54 shows another means of supporting the plants 73 consisting of an array of strategically spaced slender members 77 made from such material as piano wire, polyfilament or small diameter hollow tubing, formed in the shape of arches, spanning one or more plants 73 and secured to the planter 35 at designated anchor points 78. The plant stems 73 are intertwined about these structure.

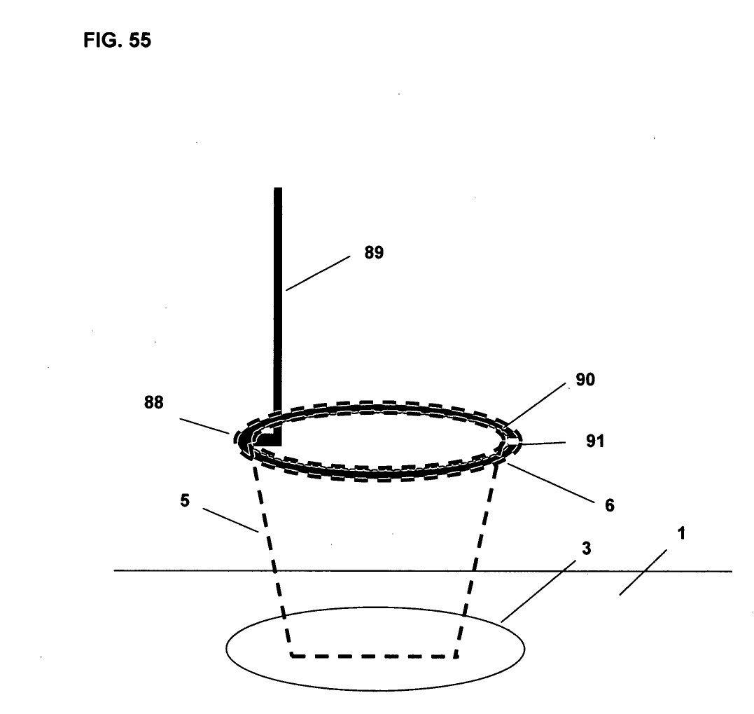

FIG. 55 shows another means of supporting the plants consisting of a ringed structure 88 that is comprised of a base ring 90 that is installed between the upper rim 6 of the pot 5 and the opening 3 in the tubular body and a vertical member onto which the plant stems are secured. The base ring 90 conforms to the general shape of the rim 6 of the pot 5 with a size slightly larger than the opening 3 into which the pot fits. The base ring 90 may contain a slot 91 to facilitate installation.

### Aesthetics

The outer surface of the planter may be painted or covered with fabric, vinyl wall covering, contact paper and other ways to match or compliment the color and texture of the mounting surface and surrounding decor. It is desirable to make it visually blend with the mounting surface so as to accentuate the foliage.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as generally defined in the appended claims.

I claim:

1. A planter device mountable on a wall having an upper, generally horizontal end surface, the wall end surface having a width, the planter device comprising:
a. A generally tubular main body disposeable generally upon the wall end surface, the body having an interior chamber configured to contain at least a portion of a plant and at least one access opening extending into the chamber, the access opening configured to provide access to the interior chamber and clearance for the plant, the main body having a width substantially equal to the width of the wall end surface.

2. The planter device as recited in claim 1 wherein the wall has opposing, generally vertical surfaces and the tubular main body has opposing side surfaces, the main body being sized such that each body side surface is generally flush with a separate one of the wall vertical surfaces when the body is disposed on the wall end surface.

3. The planter device as recited in claim 1 further comprising means for connecting the tubular main body to the wall.

4. The planter device as recited in claim 3 wherein the connection means includes at least one of:
a. at least one mounting bracket configured to connect the main body to the wall;
b. at least one post connected with one of the wall end surface and the main body, the post having a head, and at least one opening in the other one of the wall end surface and the main body, the post head being disposable within the opening;
c. at least one end cap connected with the tubular main body and having at least one of a post engable with an opening in the wall end surface and an opening configured to receive a post attached to the wall end surface;
d. at least one threaded fastener configured to connect the main body with the wall end surface;
e. a hook and loop pile fastener having a first portion attached to the tubular main body and a second portion attached to the wall and configured to releaseably engage with the first portion; and
f. an adhesive substance configured to bond the main body to the wall.

5. The planter device as recited in claim 3 wherein the connection means is achieved by a riveted assembly compromising:
a. A mounting bracket consisting of two portions which straddles the mounting surface and communicate with an engaging mating connection to preclude rotation in the installed condition
b. At least one pair of rivets possessing exposed heads which extend through the top of the mounting bracket
c. At least one pair of openings in the bottom portion of the end cap consisting of a hole and slot such that the diameter of the holes in the end cap is slightly larger than the head of the rivets and the slot in the end cap is slightly wider than the stems of the rivets
d. A threaded fastener in one portion of the bracket which engages a threaded hole in the mating bracket
and assembly consisting of placing the planter on to the mounting bracket such that the rivets engage the holes in the end cap and as the fastener is tightened, the rivets advance through the slots and draws the planter down to the mounting surface.

6. The planter device as recited in claim 3 wherein the means of attachment consist of a mounting band comprising:
a. A detachable band that envelops the tubular body and approximately conforms to it's surface.
b. Interlocking tabs at the ends of the band which lock the ends together creating a tight fit between the mounting band and tubular body.
c. Tab extensions which fasten the assembly to the mounting surface.

7. The planter device as recited in claim 1 further comprising at least one pot disposeable within the at least one opening and having a cavity configured to contain at least a portion of the plant, the pot having at least one opening fluidly connecting the cavity with the main body interior chamber.

8. The planter device as recited in claim 7 wherein the main body has an outer surface, at least one access opening extending from the outer surface into the interior chamber, and the container includes a generally cylindrical body having an open upper end and a support lip extending radially outwardly from the upper end, the lip being disposeable upon the main body outer surface to support the pot cylindrical body within the opening.

9. The planter as recited in claim 1 wherein the main body possesses longitudinal ridges along the top edges which form a barrier to preclude spillage when filling and the said ridges may be hollow in cross section to accommodate distribution tubing used by said planter and adjoining planters comprising a network.

10. The planter device as recited in claim 1 wherein the tubular main body has opposing ends and the planter device further comprises at least one end cap connectable with the main body and configured to at least one of generally enclose and generally seal one of the body ends.

11. The planter device as recited in claim 10 wherein the at least one end cap is one of:
a. connected with the one body end and configured to seal the body open end; and
b. integrally formed with the body end.

12. The planter device as recited in claim 11 wherein:
a. the planter device further comprises a connector tube configured to connect the main body with another main body; and
b. the end cap includes a first enclosed wall disposeable within the body open end so as to be at least partially disposed within the interior chamber and an outer outer enclosed wall connected with and spaced radially outwardly from the inner wall and configured to receive at least a portion of the connector tube such that the end cap connects the main body and the connecting tube.

13. The planter device as recited in claim 10 wherein the end cap is connectable with the wall so as to mount the planter device to the wall.

14. The planter as recited in claim 1 wherein the main body has a length, a top surface and at least one side surface; and a plurality of the access openings extend into the main body from one of the top surface and the side surface, the plurality of openings being spaced apart along the body length.

15. The planter device as recited in claim 1 wherein the main body has a bottom wall and the planter device further comprises at least one interior wall disposed within the interior chamber and spaced from the bottom wall so as to define a cavity section, the wall having a plurality of openings configured to fluidly connect the cavity section with a remainder of the interior chamber.

16. The planter device as recited in claim 1 wherein the main body has a length and radial cross-sections generally perpendicular to the body length, each cross-section being one of generally rectangular, generally circular, generally polygonal and complex-shaped.

17. The planter device as recited in claim 1 wherein the main body is of two piece construction comprising:
a. An upper section containing openings along its length which access the interior of the tubular body and contains interlocking slots along the longitudinal edges which engage and retain the lower section.
b. A lower section which forms the bottom and sides and contains interlocking slots along the longitudinal edges which engage and retain the upper section.

18. The planter device as recited in claim 1 wherein an air pump is configured to discharge air within the interior chamber and one of disposed within the main body interior chamber and disposed externally of the main body.

19. The planter device as recited in claim 18 wherein the main body has a length and the at least one air line includes a perforated tube extending along at least a portion of the body length.

20. The planter device as recited in claim 19 wherein the planter device includes at least first and second tubular main bodies, the air pump is disposed in the first main body and a portion of the at least one air line extends into the second main body.

21. The planter device as recited in claim 18 further comprising at least one of:
a. a flow control valve coupled with the at least one air line and configured to regulate air flow rate; and
b. a timer configured to activate the air pump at prescribed time intervals.

22. The planter device as recited in claim 1 further comprising:
a. a supply of a plant nutrient substance;
b. a pump fluidly coupled with the supply and configured to discharge the nutrient substance into the main body interior chamber.

23. The planter device as recited in claim 22 wherein each one of the supply and the pump is one of disposed within the main body interior chamber and disposed externally of the main body.

24. The planter device as recited in claim 22 further comprising at least one of:
a. at least one fluid line coupled with the pump, disposed at least partially within the main body interior chamber and configured to dispense the nutrient at various locations within the interior chamber:
b. a drain cavity defined in the interior chamber and configured to collect unused quantities of the nutrient substance for recirculation to the supply; and
c. a timer configured to activate the pump at prescribed time intervals.

25. A planter device mountable on a wall having an upper, generally horizontal end surface, the end surface having a width, the planter device comprising:
a. first and second generally tubular main bodies each disposeable upon the wall end surface, each body having an interior chamber configured to contain at least a portion of a separate plant and at least one access opening extending into the chamber, the access opening being configured to provide access to the interior chamber and clearance for the plant, the body having a width substantially equal to the width of the wall end surface; and
b. at least one coupler assembly configured to connect the first and second main bodies and to fluidly couple the interior chambers of the two bodies.

26. The planter device as recited in claim 25 wherein the wall end surface has a length and the planter device includes a plurality of the tubular main bodies spaced along at least a portion of the length of the wall end surface.

27. The planter as recited in claim 1 wherein a means is provided to provide structural support to the plants.

28. The planter as recited in claim 27 with the means of support consisting of a slender member that is formed in the shape of an arch and positioned above the top surface of the planter and secured to the planter at each end and containing slots which engage the stem of the plants.

29. The planter as recited in claim 27 with the means of support consisting of a slender member that is positioned above the planter and aligned parallel to the top surface of the planter, secured to each end of the planter and containing slots which engage the stem of the plants.

30. The planter as recited in claim 27 with the means of support consisting of a plurality of slender members formed in the shape of arches that are attached to the top surface of planter and straddle one or more plants upon which the plant stems are secured.

31. The planter as recited in claim 27 with the means of support consisting of a ringed structure that is comprised of a base ring that is installed between the upper rim of the pot and the opening in the tubular body and a vertical member onto which the plant stems are secured wherein the base ring 90 conforms to the general shape of the upper rim of the pot with a size slightly larger than the opening into which the pot fits.

32. The planter as recited in claim 1 that contains a transparent dome cover which fastens to the top of the tubular body and extends along it's length.
